(19) United States
(12) Patent Application Publication
(10) Pub. No.: US 2026/0042692 A1
(43) Pub. Date: Feb. 12, 2026

(54) TREATMENT METHOD FOR FULL RESOURCE RECOVERY FROM SLUDGE IN MUNICIPAL WASTEWATER TREATMENT PLANTS

(71) Applicant: SHANGHAI JIAO TONG UNIVERSITY, Shanghai (CN)

(72) Inventors: Nanwen ZHU, Shanghai (CN); Jinwen Hu, Shanghai (CN); Ruming Wang, Shanghai (CN); Huabo Gong, Shanghai (CN); Jinming Luo, Shanghai (CN)

(21) Appl. No.: 19/271,856

(22) Filed: Jul. 17, 2025

(30) Foreign Application Priority Data
Aug. 12, 2024 (CN) 202411099367.3

(51) Int. Cl. C02F 9/00; C01G 49/00; C02F 1/66; C02F 11/06; C02F 11/127; C05F 7/00

(52) U.S. Cl. CPC C02F 9/00; C01G 49/0018; C05F 7/005; C02F 1/66; C02F 11/06; C02F 11/127; C02F 2305/00

(57) ABSTRACT

A treatment method for full resource recovery from sludge in municipal wastewater treatment plants is provided. Ozone is used to oxidize the cell contents of sludge, and the hermetia illucens pupa shell powder slurry, polydimethyl diallyl ammonium chloride and the like are used as conditioning materials and materials for improving the water retention performance of residues. The dehydrated products are prepared into soil water retention materials, the heavy metals separated from the sludge are recovered in a ferrite way, and the organic carbon in the liquid phase is utilized as a carbon source of a wastewater treatment plant.

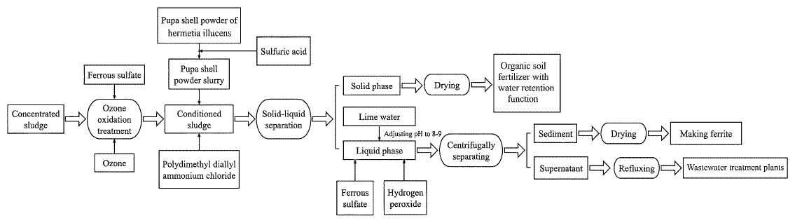

### CROSS-REFERENCE TO RELATED APPLICATIONS

This application claims priority to Chinese Patent Application No. 202411099367.3, filed on Aug. 12, 2024, the contents of which are hereby incorporated by reference.

### TECHNICAL FIELD

The disclosure relates to the technical field of environmental engineering, and in particular to a treatment method for full resource recovery from sludge in municipal wastewater treatment plants.

### BACKGROUND

In recent years, residual sludge, as a by-product of the main process of municipal wastewater treatment plants, has become a large amount of municipal organic solid waste, which is second only to municipal domestic waste.

The current sludge disposal methods mainly include land utilization, incineration, landfill and building materials utilization. However, due to the low organic matter content and high sulfide content of sludge, it is difficult for conventional anaerobic digestion to make the sludge reach the stabilization standard after treatment. Sludge is often rich in heavy metals, which will bring certain risks to subsequent disposal, and the conventional stabilization method often has high treatment cost, huge investment and waste of resources.

Therefore, achieving complete sludge treatment that ensures harmlessness, volume reduction, and resource recovery is of great significance for reducing sludge treatment costs in wastewater treatment plants and promoting the recycling of sludge.

### SUMMARY

The objective of the present disclosure is to provide a treatment method for full resource recovery from sludge in municipal wastewater treatment plants so as to reduce the organic matter content in the sludge, efficiently remove heavy metals, and improve the utilization rate of resources, thereby realizing low-cost treatment of sludge and efficient recycling of resources.

To achieve the above objective, the present disclosure provides the following scheme.

The disclosure provides a treatment method for full resource recovery from sludge in municipal wastewater treatment plants, including following steps:
(1) adding ferrous sulfate into concentrated sludge of the municipal wastewater treatment plants and performing ozone oxidation treatment to obtain sludge after ozone treatment;
(2) adding pupa shell powder slurry and polydimethyl diallyl ammonium chloride into the sludge after the ozone treatment to make a pH of the sludge be 6.1-6.8 to obtain conditioned sludge;
where a preparation method of the pupa shell powder slurry includes following steps: grinding pupa shells of hermetia illucens, adding sulfuric acid and soaking to obtain the pupa shell powder slurry;
(3) centrifuging the conditioned sludge, and drying solid phase obtained by centrifugation to obtain organic soil fertilizer with water retention function; adjusting a pH of liquid phase obtained by the centrifugation to 8-9 by lime water, then adding the ferrous sulfate and hydrogen peroxide, and centrifugally separating after reaction to obtain sediment and supernatant; and
(4) drying and calcining the sediment to obtain ferrite, where the supernatant is taken as a carbon source and refluxed to the wastewater treatment plants.

In an embodiment, in the step (1), a solid content of the concentrated sludge is 2%-3%, and an adding amount of the ferrous sulfate is 200-300 milligrams per liter (mg/L).

In an embodiment, in the step (1), an ozone concentration of the ozone oxidation treatment is 5-30 grams per cubic meter (g/m³), and a treatment time is 20-40 minutes (min).

In an embodiment, in the step (2), a mass concentration of the sulfuric acid is 30%; and a mass-volume ratio of the pupa shells of the hermetia illucens to the sulfuric acid is 30%-60%. The soaking time is over 60 min, more optionally 30-75 min.

In an embodiment, in the step (2), an adding amount of the pupa shell powder slurry in the sludge after the ozone treatment is 0.5%-2% by volume; an adding mass of the polydimethyl diallyl ammonium chloride is 0.1%-0.3% of a sludge volume after the ozone treatment by mass-volume content.

In an embodiment, in the step (3), 200-300 mg/L of the ferrous sulfate is added to the liquid phase after the pH value is adjusted according to a weight-volume ratio; 0.5%-1.0% hydrogen peroxide is added to the liquid phase after the pH value is adjusted according to a volume ratio. Optionally, a mass-volume concentration of the hydrogen peroxide is 30%.

In an embodiment, in the step (4), a calcination temperature is 850 degrees Celsius (°C.). Chemical oxygen demand (COD) of the supernatant in the step (4) is 2000-5000 mg/L, and a ratio of carbon to nitrogen is 12-20.

In this disclosure, ozone is used to oxidize the cell contents of sludge, and hermetia illucens pupa shell powder slurry, polydimethyl diallyl ammonium chloride and other materials are used as conditioning materials and materials to improve the water retention performance of residues, so that more than 40% of volatile organic matters in sludge are degraded, and more than 40% of heavy metals in sludge are removed. Dehydrated products are prepared into soil water retention materials, and the heavy metals separated from sludge are recovered in ferrite mode, and organic carbon in liquid phase is used as carbon source of wastewater treatment plants, thus realizing the fully recycling utilization of sludge.

The technical principle of the disclosure is as follows.

(1) In the disclosure, ferrous sulfate is added into sludge, and then ozone treatment is carried out, which is iron-catalyzed ozone oxidation treatment. On the one hand, ozone completely destroys bacterial cell membranes in sludge and promotes the release of polysaccharide and protein in bacteria into liquid phase. On the other hand, ozone degrades organic matters including extracellular polymeric substances in sludge, and promotes the oxidation and dissolution of reduced heavy metals combined with sludge into liquid phase, and sludge cells mainly leave skeletons such as cell walls, so that the removal rate of organic matters after sludge dehydration reaches 40%-53%.

(2) Heavy metals in sludge mainly exist in sulfide form. After ozone oxidation treatment, the removal rate of heavy metals in sludge particles is 40%-80%, and a large number of heavy metals are dissolved in liquid phase in ionic form.

(3) The pupa shell of hermetia illucens contains substances similar to chitin, and its acid leaching product has coagulation function, while polydimethyl diallyl ammonium chloride may flocculate and bridge the sludge. After conditioning, the particles mainly composed of sludge cell wall skeleton are centrifuged to form sediment. Moreover, after the pupa shell powder is treated with sulfuric acid, a large number of hydrophilic groups such as hydroxyl (—OH) and amino (—NH₂) are formed, which not only has a conditioning effect on the sludge, but also improves the water retention effect of the sediment products.

(4) As a sediment, the cell wall skeleton of sludge is mixed with pupa shell powder and polydimethyl diallyl ammonium chloride with strong hydrophilicity and water retention as conditioning agents in the process of separation, which also improves the water retention performance of dehydrated sediment.

(5) After a large amount of heavy metals in the sludge are dissolved in the liquid phase in ionic form, the pH of the liquid phase is adjusted to 8-9, and after treatment with ferrous sulfate and hydrogen peroxide, heavy metals and iron salts are coprecipitated to form ferrite sediments, which are calcined to form ferrite products. The ratio of carbon to nitrogen in the liquid phase is 12-20, which is much higher than that of the influent wastewater in the wastewater treatment plant where the ratio of carbon to nitrogen is about 4. Therefore, it may supplement the carbon source for nitrogen and phosphorus removal in the wastewater treatment plant and reduce the cost of carbon source purchase in the wastewater treatment plant.

The more specific processing steps of the disclosure are as follows.

(1) Concentrated sludge with a solid content of 2%-3% in a wastewater treatment plant is put into an ozone oxidation treatment tank, and 200-300 mg/L ferrous sulfate is added according to the weight/sludge volume ratio.

(2) The ozone generator is started to carry out ozone oxidation treatment on the sludge, with specific parameters: ozone concentration of 5-30 g/m³, aeration rate of 0.1-0.5 cubic meters per hour (m³/h), and treatment time of 20-40 min (the treatment time is subject to the removal rate of volatile organic matters exceeding 40% after sludge centrifugal treatment).

(3) The pupa shell of the hermetia illucens is ground by a crusher to make its particle size reach 1.0-10 microns, which is pupa shell powder. The pupa shell powder and sulfuric acid (concentration is 30%) are mixed according to the mass-volume ratio of 30%-60%, and treated for 30-75 min to form pupa shell powder slurry.

(4) In the sludge after ozone treatment, according to the volume and weight ratio, the pupa shell powder slurry is added into the sludge at the ratio of 0.5%-2% (Volume by Volume (V/V)), and after uniform mixing, the polydimethyl diallyl ammonium chloride is added at the ratio of 0.1%-0.3% (weight-volume ratio (W/V)). At this time, the pH of the sludge is 6.1-6.8, which is the sludge after conditioning treatment.

(5) The conditioned sludge is centrifuged, and then solid-liquid separation is carried out to form a solid phase and a liquid phase. The solid phase part may be used as organic soil fertilizer with water retention function after drying treatment.

(6) Lime water is added to the liquid phase, the pH is adjusted to 8-9, 200-300 mg/L ferrous sulfate is added according to the W/V, and 0.5%-1.0% (V/V) hydrogen peroxide with a concentration of 30% (W/V) is added according to the volume ratio. After 1 hour of reaction, centrifugal separation is carried out to form sediment and supernatant. After the sediment is dried and calcined at 850° C., ferrite (mainly composed of Fe₃O₄ and FeCr₂O₄, with iron mass fraction of 35.68-38.42%, oxygen mass fraction of 42.96-45.32% and chromium mass fraction of 8.68-11.75%) is formed, which enters the market. The COD of the supernatant may be as high as 2000-5000 mg/L, and the ratio of carbon to nitrogen is 12-20, so it may be used as high carbon-containing wastewater to return to the wastewater treatment plant as a carbon source for nitrogen and phosphorus removal in the biochemical pool, which solves the problem of insufficient carbon source for nitrogen and phosphorus removal in the wastewater treatment plant.

The disclosure discloses the following technical effects.

The disclosure may efficiently remove organic matter and heavy metals from sludge of municipal wastewater treatment plant, and improve the water retention performance of solid phase sediment by adding conditioning agents, thus facilitating its land utilization. The heavy metals in liquid phase products may be made into ferrite products and sold on the market in the form of iron salt coprecipitation, thus reducing the treatment cost of sludge, and the liquid phase containing high organic matter and high carbon-nitrogen ratio may replace the carbon source used for nitrogen and phosphorus removal in wastewater treatment plant, thus reducing the outsourcing of carbon source in wastewater treatment plant.

### BRIEF DESCRIPTION OF THE DRAWING

In order to explain the embodiments of the present disclosure or the technical scheme in the prior art more clearly, the drawings needed in the embodiments will be briefly introduced below. Obviously, the drawings described below are only some embodiments of the present disclosure, and other drawings may be obtained according to these drawings without creative work for ordinary people in the field.

The FIGURE is a process flow chart of the present disclosure.

### DETAILED DESCRIPTION OF THE EMBODIMENTS

A number of exemplary embodiments of the present disclosure will now be described in detail, and this detailed description should not be considered as a limitation of the present disclosure, but should be understood as a more detailed description of certain aspects, characteristics and embodiments of the present disclosure.

It should be understood that the terminology used in the present disclosure is only for describing specific embodiments and is not used for limiting the present disclosure. In addition, for the numerical range in the present disclosure, it should be understood that each intermediate value between the upper limit and the lower limit of the range is also specifically disclosed. Intermediate values within any stated value or stated range, as well as each smaller range between any other stated value or intermediate values within the stated range are also included in the present disclosure. The upper and lower limits of these smaller ranges may be included or excluded independently from the range.

Unless otherwise specified, all technical and scientific terms used herein have the same meaning as commonly understood by one of ordinary skill in the art to which this disclosure relates. Although the present disclosure only describes the optional methods and materials, any methods and materials similar or equivalent to those described herein may also be used in the practice or testing of the present disclosure. All documents mentioned in this specification are incorporated by reference to disclose and describe methods and/or materials related to the documents. In case of conflict with any incorporated document, the contents of this specification shall prevail.

It is obvious to those skilled in the art that many improvements and changes may be made to the specific embodiments of the present specification without departing from the scope or spirit of the present disclosure. Other embodiments obtained from the description of the present disclosure are obvious to the skilled person. The description and embodiments of the present disclosure are exemplary only.

The terms “comprising”, “including”, “having” and “containing” used herein are all open terms, which means including but not limited to.

As shown in the figure, the following embodiments describe the specific steps of a treatment method for full resource recovery from sludge in municipal wastewater treatment plants.

### Embodiment 1

Treatment of fully recycling sludge from municipal wastewater treatment plants:

(1) Concentrated sludge with a solid content of 2% is taken from a municipal wastewater treatment plant, put into an ozone oxidation treatment tank, added with 300 milligrams per liter (mg/L) (weight-volume ratio (W/V)) ferrous sulfate, and then filled with ozone with a concentration of 30 grams per cubic meter (g/m³) at an aeration rate of 0.5 cubic meters per hour (m³/h), and treated for 35 minutes (min). At this time, the removal rate of volatile organic matters and heavy metals is 50% and 55% respectively after sludge centrifugal treatment.

(2) The pupa shell of the hermetia illucens is ground by a crusher to make the particle size reach 8 microns, and then the pupa shell powder is added to sulfuric acid with a mass concentration of 30% according to the mass-volume ratio of 30%, and soaked for 75 min for later use.

(3) 1% (Volume by Volume (V/V)) of pupa shell powder slurry is added to the sludge treated by ozone in step (1), mixed evenly, and then 0.2% (W/V) of polydimethyl diallyl ammonium chloride is added to adjust the sludge, and the pH of the sludge is 6.6.

(4) Then, the sludge conditioned in step (3) is subjected to solid-liquid separation, and the solid phase part is dried to prepare a soil water retention material. In the liquid phase, lime water is added to adjust the pH to 8.0, and then 200 mg/L (W/V) ferrous sulfate and 0.5% (V/V) of hydrogen peroxide with a concentration of 30% are added. After 1 hour of reaction, the sediment and supernatant are separated by centrifugation, and the sediment is dried and calcined at 850 degrees Celsius (°C.) to make ferrite. The supernatant with chemical oxygen demand (COD) of 3500 mg/L and the ratio of carbon to nitrogen of 18 is refluxed to the wastewater treatment plant.

The soil water retention material prepared in Embodiment 1 of the present disclosure has high water absorption rate and high salt water absorption rate. The water absorption capacity reaches 620 gram per gram (g/g) after natural water absorption for 10 min, and the salt water absorption rate is 32 g/g. The water release rate is low, and the water retention capacity is strong. The water retention rate is 95.5% at 12 hours, 81% at 24 hours, 50% at 48 hours, 16% at 72 hours and 3.2% at 96 hours. The contents of heavy metals are all lower than the Soil Environmental Quality-Risk Control Standard for Soil Contamination of Agricultural Land (Trial) (GB 15618-2018). The main components of the prepared ferrite are Fe₃O₄ and FeCr₂O₄, with iron mass fraction of 35.68%, oxygen mass fraction of 45.32% and chromium mass fraction of 11.75%.

### Embodiment 2

Treatment of fully recycling sludge from municipal wastewater treatment plants:

(1) Concentrated sludge with a solid content of 3% is taken from a municipal wastewater treatment plant, put into an ozone oxidation treatment tank, added with 280 mg/L (W/V) ferrous sulfate, and then filled with ozone with a concentration of 20 g/m³ at an aeration rate of 0.4 m³/h, and treated for 40 min. At this time, the removal rate of volatile organic matters and heavy metals is 45% and 80% respectively after sludge centrifugal treatment.

(2) The pupa shell of the hermetia illucens is ground by a crusher to make the particle size reach 1 micron, and then the pupa shell powder is added to sulfuric acid with a mass concentration of 30% according to the mass-volume ratio of 40%, and soaked for 65 min for later use.

(3) 0.5% (V/V) of pupa shell powder slurry is added to the sludge treated by ozone in step (1), mixed evenly, and then 0.1% (W/V) of polydimethyl diallyl ammonium chloride is added to adjust the sludge, and the pH of the sludge is 6.1.

(4) Then, the sludge conditioned in step (3) is subjected to solid-liquid separation, and the solid phase part is dried to prepare a soil water retention material. In the liquid phase, lime water is added to adjust the pH to 8.6, and then 250 mg/L (W/V) ferrous sulfate and 0.8% (V/V) of hydrogen peroxide with a concentration of 30% are added. After 1 hour of reaction, the sediment and supernatant are separated by centrifugation, and the sediment is dried and calcined at 850° C. to make ferrite. The supernatant with COD of 5000 mg/L and the ratio of carbon to nitrogen of 20 is refluxed to the wastewater treatment plant.

The soil water retention material prepared in Embodiment 2 of the present disclosure has high water absorption rate and high salt water absorption rate. The water absorption capacity reaches 640 g/g after natural water absorption for 10 min, and the salt water absorption rate is 35 g/g. The water release rate is low, and the water retention capacity is strong. The water retention rate is 96.5% at 12 hours, 80% at 24 hours, 48% at 48 hours, 15% at 72 hours and 3.5% at 96 hours. The contents of heavy metals are all lower than the Soil Environmental Quality-Risk Control Standard for Soil Contamination of Agricultural Land (Trial) (GB 15618-2018). The main components of the prepared ferrite are Fe₃O₄ and FeCr₂O₄, with iron mass fraction of 37.21%, oxygen mass fraction of 43.65% and chromium mass fraction of 9.83%.

### Embodiment 3

(1) Concentrated sludge with a solid content of 2% is taken from a municipal wastewater treatment plant, put into an ozone oxidation treatment tank, added with 200 mg/L (W/V) ferrous sulfate, and then filled with ozone with a concentration of 5 g/m³ at an aeration rate of 0.1 m³/h, and treated for 20 min. At this time, the removal rate of volatile organic matters and heavy metals is 53% and 40% respectively after sludge centrifugal treatment.

(2) The pupa shell of the hermetia illucens is ground by a crusher to make the particle size reach 10 micron, and then the pupa shell powder is added to sulfuric acid with a mass concentration of 30% according to the mass-volume ratio of 60%, and soaked for 30 min for later use.

(3) 2% (V/V) of pupa shell powder slurry is added to the sludge treated by ozone in step (1), mixed evenly, and then 0.3% (W/V) of polydimethyl diallyl ammonium chloride is added to adjust the sludge, and the pH of the sludge is 6.8.

(4) Then, the sludge conditioned in step (3) is subjected to solid-liquid separation, and the solid phase part is dried to prepare a soil water retention material. In the liquid phase, lime water is added to adjust the pH to 9.0, and then 300 mg/L (W/V) ferrous sulfate and 1.0% (V/V) of hydrogen peroxide with a concentration of 30% are added. After 1 hour of reaction, the sediment and supernatant are separated by centrifugation, and the sediment is dried and calcined at 850° C. to make ferrite. The supernatant with COD of 2000 mg/L and the ratio of carbon to nitrogen of 12 is refluxed to the wastewater treatment plant.

The soil water retention material prepared in Embodiment 3 of the present disclosure has high water absorption rate and high salt water absorption rate. The water absorption capacity reaches 600 g/g after natural water absorption for 10 min, and the salt water absorption rate is 33 g/g. The water release rate is low, and the water retention capacity is strong. The water retention rate is 94.5% at 12 hours, 83% at 24 hours, 52% at 48 hours, 16% at 72 hours and 4.2% at 96 hours. The contents of heavy metals are all lower than the Soil Environmental Quality-Risk Control Standard for Soil Contamination of Agricultural Land (Trial) (GB 15618-2018). The main components of the prepared ferrite are Fe₃O₄ and FeCr₂O₄, with iron mass fraction of 36.94%, oxygen mass fraction of 44.86% and chromium mass fraction of 10.32%.

### Embodiment 4

(1) Concentrated sludge with a solid content of 3% is taken from a municipal wastewater treatment plant, put into an ozone oxidation treatment tank, added with 240 mg/L (W/V) ferrous sulfate, and then filled with ozone with a concentration of 10 g/m³ at an aeration rate of 0.2 m³/h, and treated for 20 min. At this time, the removal rate of volatile organic matters and heavy metals is 40% and 75% respectively after sludge centrifugal treatment.

(2) The pupa shell of the hermetia illucens is ground by a crusher to make the particle size reach 15 micron, and then the pupa shell powder is added to sulfuric acid with a mass concentration of 30% according to the mass-volume ratio of 50%, and soaked for 70 min for later use.

(3) 1.5% (V/V) of pupa shell powder slurry is added to the sludge treated by ozone in step (1), mixed evenly, and then 0.1% (W/V) of polydimethyl diallyl ammonium chloride is added to adjust the sludge, and the pH of the sludge is 6.5.

(4) Then, the sludge conditioned in step (3) is subjected to solid-liquid separation, and the solid phase part is dried to prepare a soil water retention material. In the liquid phase, lime water is added to adjust the pH to 8.4, and then 280 mg/L (W/V) ferrous sulfate and 0.8% (V/V) of hydrogen peroxide with a concentration of 30% are added. After 1 hour of reaction, the sediment and supernatant are separated by centrifugation, and the sediment is dried and calcined at 850° C. to make ferrite. The supernatant with COD of 3000 mg/L and the ratio of carbon to nitrogen of 15 is refluxed to the wastewater treatment plant.

The soil water retention material prepared in Embodiment 4 of the present disclosure has high water absorption rate and high salt water absorption rate. The water absorption capacity reaches 590 g/g after natural water absorption for 10 min, and the salt water absorption rate is 38 g/g. The water release rate is low, and the water retention capacity is strong. The water retention rate is 94.8% at 12 hours, 82% at 24 hours, 51% at 48 hours, 17% at 72 hours and 3.8% at 96 hours. The contents of heavy metals are all lower than the Soil Environmental Quality-Risk Control Standard for Soil Contamination of Agricultural Land (Trial) (GB 15618-2018). The main components of the prepared ferrite are Fe₃O₄ and FeCr₂O₄, with iron mass fraction of 38.42%, oxygen mass fraction of 42.96% and chromium mass fraction of 8.68%.

In the disclosure, 200-300 mg/L ferrous sulfate and 5-30 g/m³ ozone are added to the concentrated sludge for oxidation treatment, and then the prepared pupa shell powder slurry with coagulation function and polydimethyl diallyl ammonium chloride are added for centrifugal separation. The solid phase part is dried to make water retention material, lime water is added to the liquid phase part to adjust the pH to 8-9, and ferrous sulfate and hydrogen peroxide are added to react and then are separated again. The separated sediment is dried and calcined to make ferrite, and the supernatant is refluxed to the wastewater treatment plant with high COD as carbon source. The disclosure may realize the resource utilization of sludge, and has the advantages of simple method, low treatment cost, high resource utilization rate and the like.

The above-mentioned embodiments only describe the optional mode of the disclosure, and do not limit the scope of the disclosure. Under the premise of not departing from the design spirit of the disclosure, various modifications and improvements made by ordinary technicians in the field to the technical scheme of the disclosure shall fall within the protection scope determined by the claims of the disclosure.

What is claimed is:

1. A treatment method for full resource recovery from sludge in municipal wastewater treatment plants, comprising following steps:
(1) adding ferrous sulfate into concentrated sludge of the municipal wastewater treatment plants and performing ozone oxidation treatment to obtain sludge after ozone treatment;
(2) adding pupa shell powder slurry and polydimethyl diallyl ammonium chloride into the sludge after the ozone treatment to make a pH of the sludge be 6.1-6.8 to obtain conditioned sludge;
wherein a preparation method of the pupa shell powder slurry comprises following steps: grinding pupa shells of hermetia illucens, adding sulfuric acid and soaking to obtain the pupa shell powder slurry;
(3) centrifuging the conditioned sludge, and drying solid phase obtained by centrifugation to obtain organic soil fertilizer with water retention function; adjusting a pH of liquid phase obtained by the centrifugation to 8-9 by lime water, then adding the ferrous sulfate and hydrogen peroxide, and centrifugally separating after reaction to obtain sediment and supernatant; and
(4) drying and calcining the sediment to obtain ferrite, wherein the supernatant is taken as a carbon source and refluxed to the municipal wastewater treatment plants; wherein
in the step (1), a solid content of the concentrated sludge is 2%-3%, and an adding amount of the ferrous sulfate is 200-300 mg/L;
in the step (1), an ozone concentration of the ozone oxidation treatment is 5-30 g/m³, and a treatment time is 20-40 min;
in the step (2), a mass concentration of the sulfuric acid is 30%; a mass-volume ratio of the pupa shells of the hermetia illucens to the sulfuric acid is 30%-60%; and a soaking time is 30-75 min;
in the step (2), an adding amount of the pupa shell powder slurry in the sludge after the ozone treatment is 0.5%-2% by volume; an adding mass of the polydimethyl diallyl ammonium chloride is 0.1%-0.3% of a sludge volume after the ozone treatment by mass-volume content;
in the step (3), 200-300 mg/L of the ferrous sulfate is added to the liquid phase after the pH is adjusted according to a weight-volume ratio; 0.5%-1.0% of the hydrogen peroxide is added to the liquid phase after the pH is adjusted according to a volume ratio; and
in the step (4), a calcination temperature is 850°C.

2. The treatment method according to claim 1, wherein a mass-volume concentration of the hydrogen peroxide is 30%.

3. The treatment method according to claim 1, wherein chemical oxygen demand (COD) of the supernatant in the step (4) is 2000-5000 mg/L, and a ratio of carbon to nitrogen is 12-20.
